(19) United States
(12) Patent Application Publication
(10) Pub. No.: US 2004/0150142 A1
(43) Pub. Date: Aug. 5, 2004

(54) Steering beam axle air spring suspension

(76) Inventors: Derek K. Warinner, Fort Wayne, IN (US); Jeffrey T. Henry, Fort wayne, IN (US); James J. Korson, Fort Wayne, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 10/358,610

(22) Filed: Feb. 5, 2003

(51) Int. Cl. F16F 1/04

(52) U.S. Cl. 267/3

(57) ABSTRACT

A suspension system for a vehicle frame from a steering axle has first and second air springs mounted on the steering axle and directly below the frame to support a portion of vehicle weight. A trailing U-shaped stabilizer bar functions as a roll stiffener, lateral control element and fore-aft movement control element. Upper torque rods are positioned over the U-shaped stabilizer bar, creating an effective parallelogram linkage with the stabilizer bar on each side of the vehicle.

### BACKGROUND OF THE INVENTION

1. Field of the Invention

The present invention relates to vehicle front end suspension systems and, more particularly, to a suspension system for a beam axle utilizing an air spring as the sole support element and incorporating a multiple function stabilizer bar which also provides fore-aft and lateral position control of the axle.

2. Background:

Vehicle suspension systems are designed in view of several not wholly compatible goals which include: absorbing road shock; stabilizing the vehicle; maintaining proper axle spacing and alignment; supporting the vehicle; maintaining the operator's ability to control the vehicle; and providing a comfortable ride. Meeting these goals in a commercial truck is further complicated by the fact that the vehicle's weight will vary greatly with changing loads.

Four basic categories of suspension systems are used on trucks, categorized by the type of spring used: leaf spring systems; equalizing beam systems; torsion bar systems; and air spring systems. Of these categories air springs and leaf springs are the most popular. Air spring systems have been applied to a variety of truck axles, including of particular interest here, the steering axle. Air spring suspensions give excellent load and vibration isolation to the cab by eliminating the interleaf friction found in traditional multiple metal leaf spring designs. The deflection rate of air springs can be adjusted automatically to compensate for vehicle load changes. As a result, overall vehicle height does not vary with changes in the load. In addition, an air spring usually has a lower deflection rate than a leaf spring exerting the same force giving an air spring a potentially greater capacity for absorbing shocks for a given displacement between the axle and the frame. However, air springs provide poorly directed support, and have required more extensive auxiliary stabilizing elements for the axle than have leaf spring designs. Leaf springs are conventionally attached to an axle using a U-bolt clamp assembly, which is complicated and adds weight to the vehicle.

Hybrid designs of air and leaf based systems have been proposed for a steering axle. In one hybrid design, U.S. Pat. No. 4,919,399, an air spring has supplemented a leaf spring by being placed between the leaf spring and the vehicle frame directly over the axle and beneath the side rails of a truck's frame. A leaf spring provides two frame mounting points fore and aft of the steering axle to aid in stability. Arrangements combining the use of air springs and leaf springs, while effective and potentially simple, reintroduce some of the ride disadvantages of traditional leaf spring designs. They also reduce the space available for the air spring reducing its travel and spring rate limits.

### SUMMARY OF THE INVENTION

It is an object of the invention to provide an air spring suspension system with simplified position stabilization for the axle.

It is a further object of the invention to provide an air spring suspension system having improved resistance to roll.

It is still another object of the invention to provide a suspension system which enhances steering axle lateral stability without use of a track bar.

It is still another object of the invention to provide a suspension system which has good fore to aft control over the position of the axle.

The foregoing objects are achieved as is now described. The invention provides a suspension system for a steering axle. First and second low hysteresis springs are mounted to locally support frame rails directly above the steering axle. Left and right side attachment brackets extend forward from the axle. Left and right side hanger brackets depend from the left and right side frame rails forward of the axle and the attachment brackets. The hanger brackets are longitudinally aligned with the left and right side attachment brackets, respectively. An approximately U-shaped stabilizer bar is pivotally attached at each of two ends to the left and right side attachment brackets and pivotally mounted through the left and right side hanger brackets to provide left and right side trailing control rod sections between the hanger brackets and the attachment brackets. Left and right side upper torque rods are pivotally attached at their ends to the hanger brackets and the attachment brackets to be substantially parallel to the trailing control rod sections of the approximately U-shaped stabilizer bar to form, together with the control rod section left and right side parallelogram trailing linkages integrated with the stabilizer bar.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is perspective view of a portion of a vehicle frame incorporating the invention;

FIG. 2 is a top plan view of a portion of a vehicle frame illustrating the inventive suspension system; and

FIG. 3 is a front elevation of the suspension system;

FIG. 4 is a perspective view of the portion of the suspension system; and

FIG. 5 is a side elevation of the portion of the suspension system.

### DETAILED DESCRIPTION OF THE INVENTION

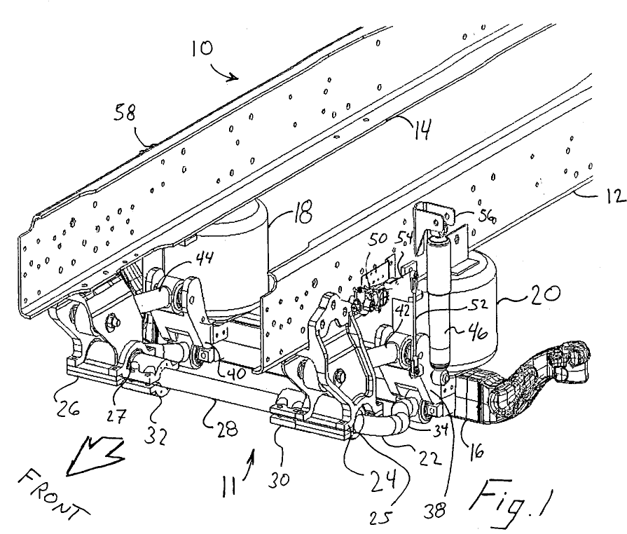

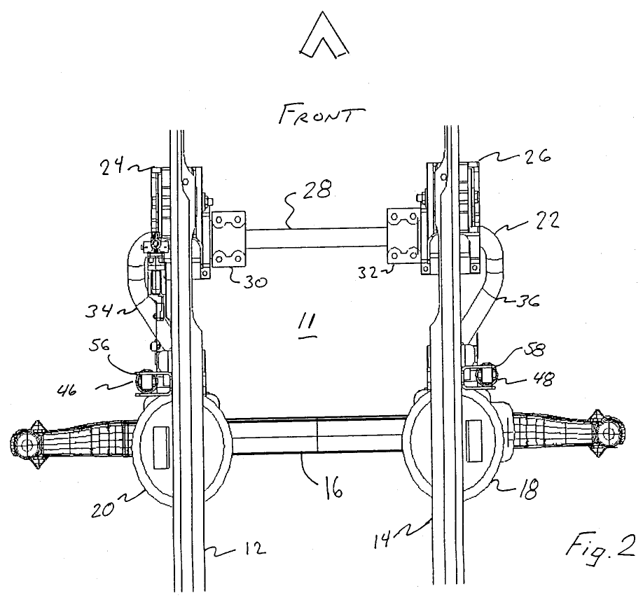

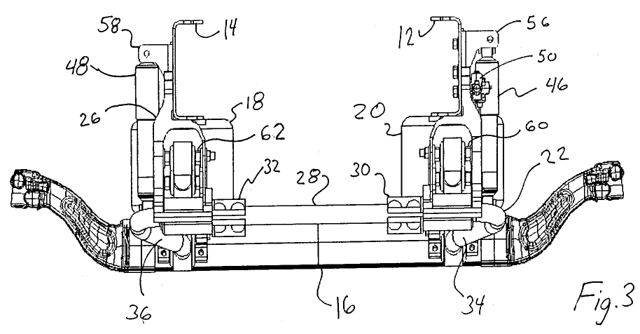

Referring to the figures and particularly to FIGS. 1-3, a portion of a vehicle frame 10 with which the steering axle suspension system 11 of the present invention has been incorporated is illustrated. Vehicle frame 10 includes a left side rail 12 and a right side rail 14 which are attached to one another using a plurality of cross members (not shown). Frame 10 is supported through side rail members 12 and 14 above a steering axle 16 by suspension system 11. While the invention is depicted with a conventional truck frame based on left and right side longitudinal rails, it may be equally effectively applied to vehicles constructed with different types of frame assemblies or using a unibody.

Suspension system 11 supports vehicle frame 10 from steering axle 16 and simultaneously keeps the steering axle in the appropriate orientation with respect to the frame. Support is provided by a right side air spring 18 and a left side air spring 20. Air springs 18 and 20 are low hysteresis springs for reducing the transmission of minor shocks and road noise to the passengers of the vehicle. Air springs are one example of a low-hysteresis spring which are well-known in the art. Steering axle 16 is a beam axle of a type well-known to heavy duty trucks. Air springs 18 and 20 are illustrated as mounted directly on top of steering axle 16 and directly under side rails 14 and 12 respectively. While air springs 18 and 20 support frame 10 from the steering axle 16 and provide shock absorption, they are insufficient to stabilize the position of axle 16 relative to frame 10. Although air springs are used with the preferred embodiment of the invention other spring systems may be used.

Steering axle 16 is positionally stabilized in part by a trailing U-shaped stabilizer bar 22 and by trailing left and right side upper torque rods 42 and 44. Attachment of the stabilizer bar 22 and the two trailing upper torque rods 42 and 44 to steering beam axle 16 is provided by forward oriented left and right side attachment brackets 38 and 40, which are welded to and extend from the forward face of the beam axle 16. Attachment of stabilizer bar 22 and upper torque rods 42 and 44 with respect to frame 11 is effected using left side and right side front hanger brackets 24 and 26. Both stabilizer bar 22 and the upper torque rods 42 and 44 are located below frame 11.

U-shaped stabilizer bar 22 is located below the upper torque rods 38 and 40 and forward from axle 16 and is coupled in a trailing manner from frame 11 to axle 16. The top of the “U” is open towards axle 16. The orientation of stabilizer bar 22 can be reversed without loss of functionality. U-shaped stabilizer bar 22 has three major sections, a base section 28 which lies parallel to and forward from axle 16, and left and right legs 34 and 36 which extend from the base section toward the steering axle, attaching to the axle at their ends. The ends of left and right legs 34 and 36 are pivotally attached to the lower parts of attachment brackets 38 and 40 and extend generally forward from axle 16 in the plane of side frame rails 12 and 14. The attached ends of legs 34 and 36 have a single pivot axis parallel to axle 16. Base section 28 of U-shaped stabilizer bar 22 is located further forward and is pivotally mounted between left side and right side hanger brackets 24 and 26. The pivot attachment points 25 and 27 for base section 28 are substantially directly in front of the attachment points for the legs of stabilizer bar 22. Base section 28 is perpendicular to frame side rails 12 and 14. Lateral walk of stabilizer bar 22 is prevented by left and right inside lateral clamps 30 and 32, which are collar shaped fittings seated around the stabilizer bar just inside of the left side and right side hanger brackets 24 and 26, respectively, on the base section 28.

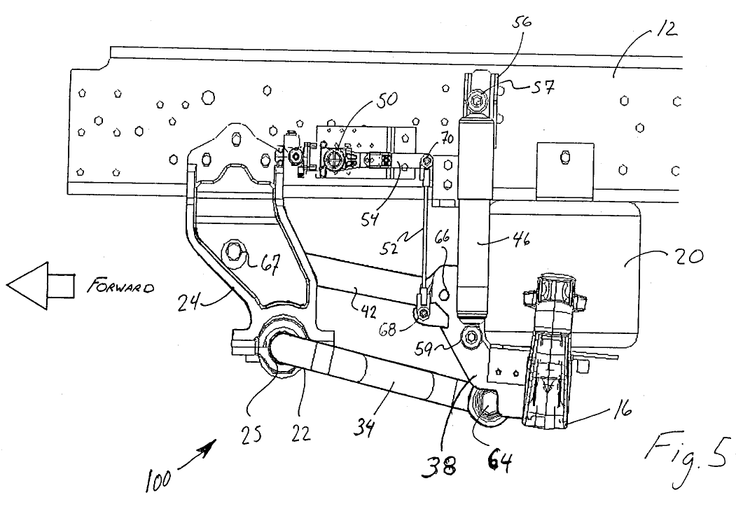

Left side and right side upper torque rods 42 and 44 are each pivotally attached at one end to the left and right side axle attachment brackets 38 and 40 and by their remaining ends into the left side and right side hanger brackets 24 and 26, respectively. Upper torque rods 42 and 44 are substantially parallel to the legs 34 and 36 of U-shaped stabilizer bar 22, the points of attachment of the rods in the attachment brackets 38 and 40 being spaced above the points of attachment of the legs by about the same distance spacing the points of attachment of the legs from the mountings for the base section 28 in the left side and right side forward hanger brackets 24 and 26. The arrangement of the points of attachment between the upper torque arms and U-shaped stabilizer bar are described in greater detail below with reference particularly to FIG. 5.

Left and right side shock absorbers 46 and 48 are positioned parallel to left and right side air springs 20 and 18, respectively, being pivotally attached at lower ends to the attachment brackets 38 and 40 and at the upper ends to the left and right side frame rails 12 and 14.

Air is added or released from air springs to maintain vehicle height. A height control air valve 50 is installed on the outside face of left side frame rail 12 forward from axle 16. A valve actuation lever 54 extends back from air valve 50 toward axle 16 parallel with the direction of elongation of frame rail 12. A height control arm is coupled between the free end of lever 54 and a point on the left side attachment bracket 38. Depression or extension of the spacing between axle 16 and frame 11 results in arm 52 moving lever 54 up or down. This movement of lever 54 results in air being added or released from air springs 18 and 20. Transient shocks should not result in adjustment of vehicle height and accordingly, sustained depression or extension of the spacing, such as result from changes in load, is required before substantial changes in pressurization of the air springs 18 and 20 result. Height control valves may be placed on both sides of the vehicle with one valve controlling the air pressure in each air spring, or one valve may be mounted on either side and may be used to control the pressure in both springs.

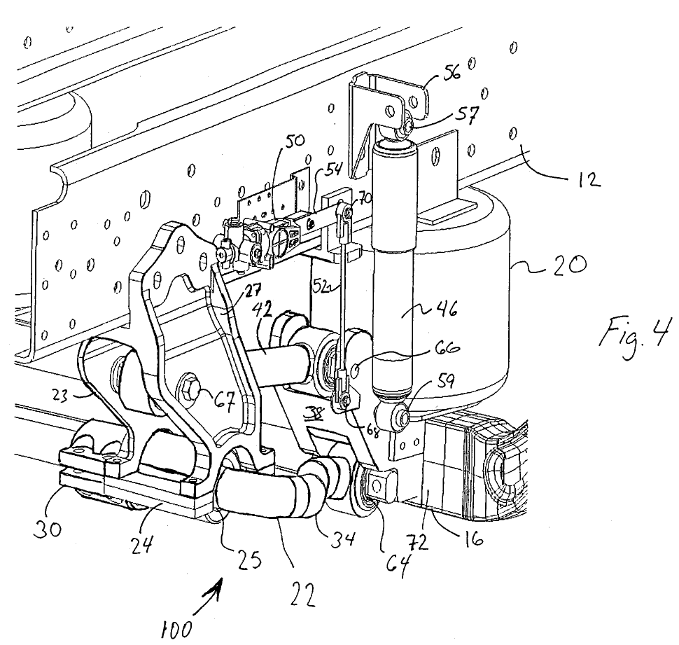

Referring now to FIGS. 4 and 5 a parallelogram linkage 100 such as formed by the legs 34 and 36 of the U-shaped stabilizer bar, the forward left and right side hanger brackets 24 and 26, the left and right side upper torque rods 42 and 44 and the axle attachment brackets 38 and 40 are described with greater particularity. Since the linkages from the left and right sides are near mirror images of one another, with the exception of provision of the height control arrangements illustrated for the vehicle's left side, only the parallelogram linkage 100 for the left side is illustrated and discussed.

Parallelogram linkage 100 is anchored in two opposed brackets, a forward hanger bracket 24, which depends from and extends downwardly from left side frame rail 12 and an axle attachment bracket 38, which is welded to the front face 72 of steering beam axle 16. Hanger bracket 24 and attachment bracket 38 are aligned with one another under left side frame rail 12. Torque rod 42 is captured between hanger bracket 24 and attachment bracket 38, positioning the torque rod below and substantially in the plane of left side rail 12. The forward end of upper torque rod 42 is captured on a pivotal mount 67 through an inside flange 23 and an outside flange 27, giving the upper torque rod an axis of rotation perpendicular to the direction of elongation of left side frame rail 12 and limiting movement of the rod to a plane. The opposite end of torque rod 42 is similarly captured in a pivot mount 66 through attachment bracket 38. Again the axis of rotation of pivot mount 66 is parallel to the direction of elongation of axle 16.

U-shaped torsion bar 22 lies below upper torque rod 42 and its left side leg 34 performs the function of a lower control arm in parallelogram linkage 100. Base section 28 of U-shaped torsion bar 22 is captured near a bend in the torsion bar in bushing 25 held in the lower portion of hanger bracket 24. The axis of capture is spaced both below and behind the pivot mount 67. The end of leg 34 distal to bushing 25 is captured on a pivot mount 64 through attachment bracket 38. The axis of rotation defined by pivot mount 64 is located behind and below the axis of pivot mount 66 which are spaced comparably to the spacing between bushing 25 and mount 67. The axis of rotation of mount 64 is parallel to axle 16 and to the other axes of rotation at each of the four corners of the parallelogram linkage 100. Parallelogram linkage 100 gives axle 16 a flattened arc of movement centered on the forward hanger bracket 24.

Attachment bracket 38 provides a convenient location for the attachment of other auxiliary components of suspension system 11, including the lower ends of shock absorber 46 and height control arm 52. Shock absorber 46 dampens relative movement of left side frame rail 12 and axle 16 between positionally fixed at each end with respect to the two elements. The lower end of shock absorber 46 is attached to an outside face of attachment bracket 38 by a pivot mount 59. The upper end of shock absorber 46 is captured on a pivot mount 57, which is positioned in and mounted to a bracket 56 which extends outwardly from the outer face of left side frame rail 12. The axes of rotation of mounts 57 and 59 are parallel to one another and to the axes of rotation of the pivot mounts of parallelogram linkage 100. Similarly the lower end of height control arm 52 is pivotally attached on a joint 68 depending from attachment bracket 38. The upper end of height control arm 52 is attached on a joint 70 to the free end of height control valve lever 54, which is in turn connected to height control valve 50. Valve 50 is mounted on the outward face of left side frame rail 12.

The invention of the present patent provides an advantageous balance between ride and handling performance by using air springs as the sole support element. A stabilizer bar serves as its conventional role as a role stiffener as well as providing lower fore-aft control and limiting lateral movement of the axle. The multiple functions met by the stabilizer bar simplify the suspension and save weight over prior art suspensions which met these requirements using discrete components. The axle attachment bracket is simplified over common U-bolt clamp group assemblies.

While the invention is shown in only one of its forms, it is not thus limited but is susceptible to various changes and modifications without departing from the spirit and scope of the invention.

What is claimed is:

1. A suspension system for a vehicle having an axle and a chassis including parallel left and right side frame rails above and perpendicular to the axle, the suspension system comprising:
left and right side low hysteresis springs, each low hysteresis spring being located on the axle and directly below its respective side frame rail for supporting the chassis from the axle;
left and right side anchoring brackets extending forward from the axle;
left and right side hanger brackets depending from the left and right side frame rails forward of the axle and aligned with the left and right side anchoring brackets, respectively;
an approximately U-shaped stabilizer bar pivotally attached at each of two ends to the left and right side anchoring brackets and pivotally mounted through the left and right side hanger brackets to provide left and right side trailing control rod sections between the hanger brackets and the anchoring brackets; and
left and right side upper torque rods pivotally attached at their ends to the hanger brackets and the anchoring brackets to be substantially parallel to the trailing control rod sections of the approximately U-shaped stabilizer bar to form left and right side parallelogram trailing linkages.

2. A suspension system as claimed in claim 1, further comprising collars installed around the U-shaped stabilizer bar inboard from each hanger bracket preventing lateral walk of the U-shaped stabilizer bar.

3. A suspension system as claimed in claim 2, further comprising:
left and right side shock absorbers attached at one end to a side frame rail and by the other end to the anchoring brackets.

4. A suspension system as claimed in claim 3, the low hysteresis springs being air springs.

5. A suspension system as claimed in claim 4, further comprising:
height control valves mounted on the left and right side frame rails and having actuation arms; and
height control valve arms attached between a fixed point on the anchoring brackets and valve actuation arms.

6. A suspension system for a vehicle having a beam steering axle and a chassis including parallel left and right side frame rails above and perpendicular to the beam steering axle, the suspension system comprising:
first and second axially aligned pivot mounting points on the beam steering axle;
a U-shaped link having a base section, left and right side legs, the U-shaped link coupling the axle to the chassis, being mounted at free ends of its left and right side legs to the first and second axially aligned pivot mounting points, and pivotally mounted along its base section with respect to the chassis;
left and right side torque arms each pivotally attached at one end with respect to the steering axle and further pivotally attached at the remaining end with respect to the left and right side frame rails, respectively; and
left and right side low hysteresis springs mounted directly between axle and the left and right side frame rails, respectively.

7. A suspension system as claimed in claim 6, wherein the left and right side torque arms are located above and substantially parallel to the left and right side legs of the U-shaped link.

8. A suspension system as claimed in claim 7, wherein the U-shaped link is mounted as a trailing link between the chassis and the beam steering axle.

9. A suspension system as claimed in claim 8, wherein the coupling of the U-shaped link with respect to the axle is by the ends of the left and right side legs and with respect to the left and right side frame rails by the base section and a first point of attachment of the base section and the point of attachment of the left side leg are aligned with the left side frame rail and a second point of attachment of the base section and the point of attachment of the right side leg are aligned with the right side frame rail.

10. A suspension system as claimed in claim 9, further comprising:
left and right side attachment brackets extending forward from the beam steering axle providing points of attachment for the legs of the U-shaped link to the steering axle and further providing points of attachment of the ends of the torque bars with respect to the beam steering axle; and
left and right side hanger brackets depending from the left and right side frame rails respectively, the hanger brackets providing pivot mounts for the base of the U-shaped link.

11. A suspension system as claimed in claim 10, further comprising:
the low hysteresis springs being air springs.

12. A suspension system as claimed in claim 11, further comprising:
left and right side shock absorbers mounted between the left and right side attachment brackets and the left and right side frame rails, respectively.

13. A suspension system as claimed in claim 12, further comprising:
left and right side height control valves mounted on the left and right side frame rails and having actuation arms; and
left and right side height control valve arms attached between a fixed point on the attachment brackets and valve actuation arms.
